(19) United States
(12) Patent Application Publication
(10) Pub. No.: US 2017/0365067 A1
(43) Pub. Date: Dec. 21, 2017

(54) BASEBALL GAME SYSTEM

(71) Applicant: CLOUDGATE CORP., Seoul (KR)

(72) Inventor: Soonmok JANG, Namyangju-si (KR)

(21) Appl. No.: 15/622,744

(22) Filed: Jun. 14, 2017

(30) Foreign Application Priority Data
Jun. 15, 2016 (KR) 10-2016-0074299

(51) Int. Cl. G06T 7/73; G06T 5/00; A63B 24/00; A63B 69/40

(52) U.S. Cl. CPC G06T 7/74; A63B 69/40; G06T 5/009; A63B 24/0021; A63B 2024/0053; G06T 2207/20208; G06T 2207/30224; A63B 2220/807

(57) ABSTRACT

A baseball game system is capable of accurately determining a location of a ball at all times irrespective of changes in illuminance, the baseball game system including: a pitching unit pitching a ball toward a determination area including a strike zone; a photographing unit between the determination area and the pitching unit; and a location detector receiving a photographed image from the photographing unit, comparing the photographed image with a reference image, generating a corrected image by adjusting a luminance of the photographed image based on the comparison result and detecting a location of a pitched ball or a struck ball based on the corrected image.

### CROSS-REFERENCE TO RELATED APPLICATION

This application claims priority under 35 U.S.C. §119 to Korean Patent Application No. 10-2016-0074299, filed on Jun. 15, 2016, in the Korean Intellectual Property Office (KIPO), the disclosure of which is incorporated by reference herein in its entirety.

### 1. TECHNICAL FIELD

Embodiments of the present invention relate to a baseball game system, and more particularly, to a baseball game system capable of accurately determining a location of a ball at all times regardless of changes in illuminance.

### 2. DISCUSSION OF RELATED ART

A baseball game system may be located indoors. When the baseball game system is located indoors, the illuminance of the interior depends on artificial lightings inside.

An illuminance of a photographing area (that is, an area photographed by a photographing unit) may vary according to the brightness of the lighting. The illuminance change of the photographing area affects a luminance of an image taken under the illuminance. For example, the higher the illuminance of the photographing area, the larger the size of a ball of the photographed image. Further, the lower the illuminance of the photographing area, the less the size of the ball of the photographed image. Accordingly, there may arise a problem that a vertical position of the ball changes according to the change in illuminance.

It is to be understood that this background of the technology unit is intended to provide useful background for understanding the technology and as such disclosed herein, the technology background unit may include ideas, concepts or recognitions that were not part of what was known or appreciated by those skilled in the pertinent art prior to a corresponding effective filing date of subject matter disclosed herein.

### SUMMARY

Exemplary embodiments of the present invention may be directed to a baseball game system that may obtain accurate coordinates of a ball at all times irrespective of changes in illuminance by correcting a luminance of a photographed image according to a change in illuminance of a photographing area.

According to an exemplary embodiment, a baseball game system includes: a pitching unit pitching a ball toward a determination area including a strike zone; a photographing unit between the determination area and the pitching unit; and a location detector receiving a photographed image from the photographing unit, comparing the photographed image with a reference image, generating a corrected image by adjusting a luminance of the photographed image based on the comparison result and detecting a location of a pitched ball or a struck ball based on the corrected image.

The reference image may include a ball image photographed at a predetermined reference illuminance and the photographed image may include a ball image photographed at all illuminance at the time of photographing by the photographing unit.

The location detector may generate the corrected image by increasing the luminance of the photographed image when the photographed image has a less luminance value than a luminance value of the reference image and generate the corrected image by decreasing the luminance of the photographed image when the photographed image has a higher luminance value than the luminance value of the reference image.

The location detector may include: an image comparator comparing the photographed image with the reference image; and an image corrector generating the corrected image based on the comparison result from the image comparator.

The image comparator may select block luminance data located in a certain area among block luminance data of the reference image, select block luminance data located in the certain area among block luminance data of the photographed image and subtract the block luminance data selected from the reference image from each corresponding one of the block luminance data selected from the photographed image, respectively, to generate subtracted luminance data.

The image corrector may select subtracted luminance data located within a reference range among the subtracted luminance data from the image comparator, calculate an average luminance value of the selected subtracted luminance data when the number of the selected subtracted luminance data is larger than a threshold value, and generate the corrected image by correcting the luminance of the photographed image based on the average luminance value.

In the image corrector, the corrected image datum may have a higher luminance value than a luminance value of the photographed image datum when the average luminance value is less than 0, and the corrected image datum may have a less luminance value than the luminance value of the photographed image datum when the average luminance value is larger than 0.

According to another exemplary embodiment, a baseball game system includes: a pitching unit pitching a ball toward a determination area including a strike zone; a photographing unit between the determination area and the pitching unit; an illuminometer measuring an illuminance of a photographing area of the photographing unit; and a location detector receiving a photographed image from the photographing unit, generating a corrected image by adjusting a luminance of the photographed image based on the illuminance measured by the illuminometer, and detecting a location of a pitched ball or a struck ball based on the corrected image.

The corrected image may have a higher luminance value than a luminance value of the photographed image when the illuminance measured by the illuminometer is less than a reference illuminance.

The corrected image may have a less luminance value than a luminance value of the photographed image when the illuminance measured by the illuminometer is higher than a reference illuminance.

The foregoing is illustrative only and is not intended to be in any way limiting. In addition to the illustrative aspects, exemplary embodiments and features described above, further aspects, exemplary embodiments and features will become apparent by reference to the drawings and the following detailed description.

### BRIEF DESCRIPTION OF THE DRAWINGS

A more complete appreciation of the present invention will become more apparent by describing in detail exemplary embodiments thereof with reference to the accompanying drawings, wherein:

FIG. 1 is a schematic perspective view illustrating a baseball game system according to an exemplary embodiment;

FIG. 2 is a side view of FIG. 1;

FIGS. 3 and 4 are views illustrating overlap of a total of nine images taken at time intervals;

FIG. 5 is a block diagram illustrating a location detector of FIG. 1.

FIG. 6A is a view illustrating a spatial arrangement of block luminance data included in a reference image of one frame;

FIG. 6B is a view illustrating a spatial arrangement of block luminance data included in a photographed image of one frame;

FIG. 6C is a view separately illustrating only block luminance data included in a certain area among the luminance data of the reference image illustrated in FIG. 6A;

FIG. 6D is a view separately illustrating only block luminance data included in a certain area among the luminance data of the photographed image illustrated in FIG. 6B;

FIG. 6E is a view illustrating a spatial arrangement of subtracted luminance data obtained by subtracting the block luminance data illustrated in FIG. 6C from the block luminance data illustrated in FIG. 6D; and

FIG. 7 is a schematic perspective view illustrating a baseball game system according to an alternative exemplary embodiment.

### DETAILED DESCRIPTION

Exemplary embodiments will now be described more fully hereinafter with reference to the accompanying drawings. Although the invention may be modified in various manners and have several exemplary embodiments, exemplary embodiments are illustrated in the accompanying drawings and will be mainly described in the specification. However, the scope of the invention is not limited to the exemplary embodiments and should be construed as including all the changes, equivalents and substitutions included in the spirit and scope of the invention.

In the drawings, thicknesses of a plurality of layers and areas are illustrated in an enlarged manner for clarity and ease of description thereof. When a layer, area, or plate is referred to as being “on” another layer, area, or plate, it may be directly on the other layer, area, or plate, or intervening layers, areas, or plates may be present therebetween. Conversely, when a layer, area, or plate is referred to as being “directly on” another layer, area, or plate, intervening layers, areas, or plates may be absent therebetween. Further when a layer, area, or plate is referred to as being “below” another layer, area, or plate, it may be directly below the other layer, area, or plate, or intervening layers, areas, or plates may be present therebetween. Conversely, when a layer, area, or plate is referred to as being “directly below” another layer, area, or plate, intervening layers, areas, or plates may be absent therebetween.

The spatially relative terms “below”, “beneath”, “less”, “above”, “upper” and the like, may be used herein for ease of description to describe the relations between one element or component and another element or component as illustrated in the drawings. It will be understood that the spatially relative terms are intended to encompass different orientations of the device in use or operation, in addition to the orientation depicted in the drawings. For example, in the case where a device illustrated in the drawing is turned over, the device positioned “below” or “beneath” another device may be placed “above” another device. Accordingly, the illustrative term “below” may include both the lower and upper positions. The device may also be oriented in the other direction and thus the spatially relative terms may be interpreted differently depending on the orientations.

Throughout the specification, when an element is referred to as being “connected” to another element, the element is “directly connected” to the other element, or “electrically connected” to the other element with one or more intervening elements interposed therebetween. It will be further understood that the terms “comprises,” “comprising,” “includes” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that, although the terms “first,” “second,” “third,” and the like may be used herein to describe various elements, these elements should not be limited by these terms. These terms are only used to distinguish one element from another element. Thus, “a first element” discussed below could be termed “a second element” or “a third element,” and “a second element” and “a third element” may be termed likewise without departing from the teachings herein.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within +30%, 20%, 10%, 5% of the stated value.

Unless otherwise defined, all terms used herein (including technical and scientific terms) have the same meaning as commonly understood by those skilled in the art to which this invention pertains. It will be further understood that terms, such as those defined in commonly used dictionaries, should be interpreted as having a meaning that is consistent with their meaning in the context of the relevant art and will not be interpreted in an ideal or excessively formal sense unless clearly defined in the present specification.

Some of the parts which are not associated with the description may not be provided in order to specifically describe exemplary embodiments of the present invention and like reference numerals refer to like elements throughout the specification.

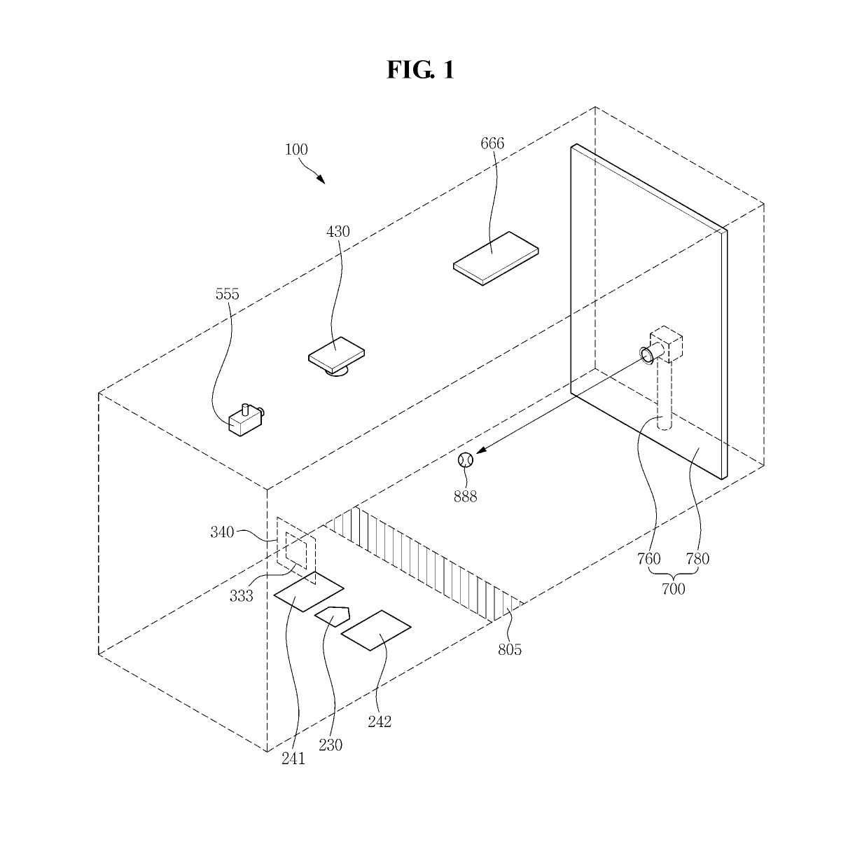

Hereinafter, a baseball game system according to an exemplary embodiment will be described in detail with reference to FIGS. 1 to 7.

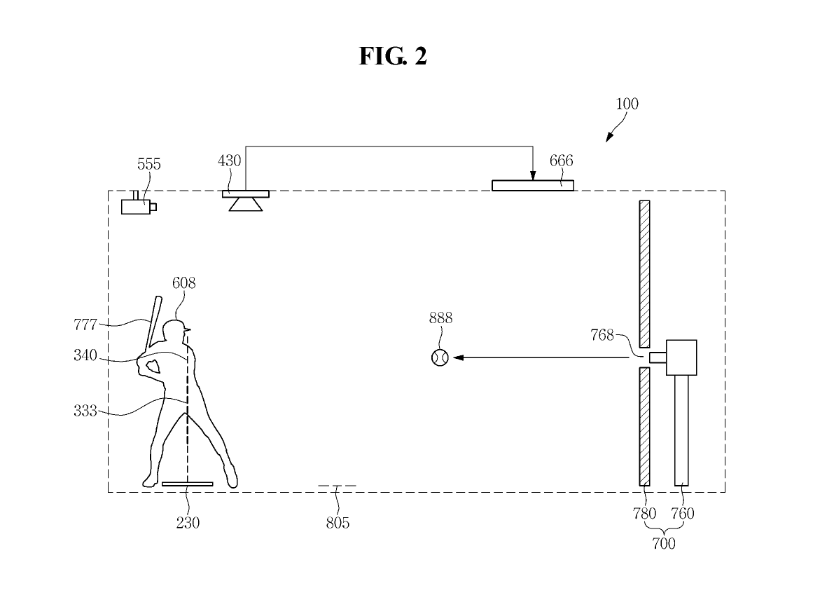

FIG. 1 is a schematic perspective view illustrating a baseball game system according to an exemplary embodiment, and FIG. 2 is a side view of FIG. 1.

As illustrated in FIGS. 1 and 2, the baseball game system 100 according to an exemplary embodiment includes a pitching unit 700, a photographing unit 430, a projector 555, a location detector 666, a first plate 241, a second plate 242 and a groove plate 230.

The pitching unit 700 pitches a ball 888 toward a determination area 340 positioned between the first plate 241 and the second plate 242.

The determination area 340 includes a strike zone 333. That is, a part of the determination area 340 is the strike zone 333. For example, the determination area 340 may be positioned between the first plate 241 and the second plate 242.

A width of the determination area 340 may be defined by a distance between the first plate 241 and the second plate 242, and a length of the determination area 340 may be defined by a distance between the groove plate 230 and an imaginary side above the groove plate 230. Herein, the imaginary side is positioned higher than an upper side of the strike zone 333.

The pitching unit 700 includes a screen 780 and a pitching machine 760.

The screen 780 is positioned between the determination area 340 and the pitching machine 760. The screen 780 displays an image projected from the projector 555. The image is displayed on a display surface of the screen 780. As illustrated in FIG. 2, the screen 780 includes at least one hole 768.

The pitching machine 760 is positioned behind the screen 780. That is, the pitching machine 760 is positioned opposite the display surface of the screen 780. The pitching machine 760 throws the ball 888. The ball 888 pitched from the pitching machine 760 passes through the hole 768 of the screen 780 and advances toward the determination area 340.

The photographing unit 430 detects a moment when the ball 888 from the pitching unit 700 enters a sensing area 805 and starts photographing. For example, the photographing unit 460 starts tracking all moving objects, including the ball 888, from the moment when the ball 888 enters the sensing area 805. To this end, the photographing unit 430 may continuously photograph at a rate of several tens to several hundreds of frames per second from the moment when the ball 888 enters the sensing area 805. The photographing unit 430 may include a high-speed camera.

The photographing unit 430 is positioned above the determination area 340. For example, as illustrated in FIG. 2, the photographing unit 430 may be positioned in a diagonal direction of the determination area 340, not directly above the determination area 340.

The location detector 666 detects a location of the ball 888 based on the image photographed by the photographing unit 430. The image provided from the photographing unit 430 includes a plurality of images (frame images). The location detector 666 may analyze the images and calculate coordinates (XY coordinates) of the ball 888 in the determination area 340. To this end, for example, the location detector 666 may binarize each image from the photographing unit 430 based on a corresponding photographing illuminance thereof to generate a black-white image, extract a basic contour (e.g., a contour of a ball) of an object (e.g., a ball) in the image by scanning the black-white image in the up-and-down direction and the left-and-right direction, determine a center position of the object from the contour, and determine a location of the object (e.g., the ball) based on the center position and a trajectory of the object (e.g., a trajectory of the ball).

The coordinate information of the ball detected by the location detector 666 is transmitted to a determination unit (not illustrated). The determination unit determines whether or not the detected coordinates of the ball are located in the strike zone 333 in the determination area. In the case where it is identified that the ball 888 is located inside the strike zone 333 or at the boundary thereof, the determination unit declares a strike. On the other hand, in the case where it is identified that the ball is located in the determination area 340 outside the strike zone 300, the determination unit declares a ball. In an exemplary embodiment, the determination unit determines final ball and strike based on a determination result from a swing determination unit (not illustrated) and the detection result from the location detector 666. For example, the swing determination unit may determine whether or not a swing of a baseball bat 777 of a batter 608 occurs based on the image from the photographing unit 430.

The image photographed by the photographing unit (hereinafter, a photographed image) includes an image corresponding to the ball. The image of the ball corresponds to a ball pitched from the pitching unit toward the determination area or a ball struck by the batter.

The ball in the image has a larger size as it approaches the photographing unit 430 due to the perspective phenomenon. That is, the size of the ball 888 in the image tells how high the ball 888 is from the ground (or the groove plate 230). In other words, a vertical position of the ball 888 may be identified from the size of the ball 888 in the image.

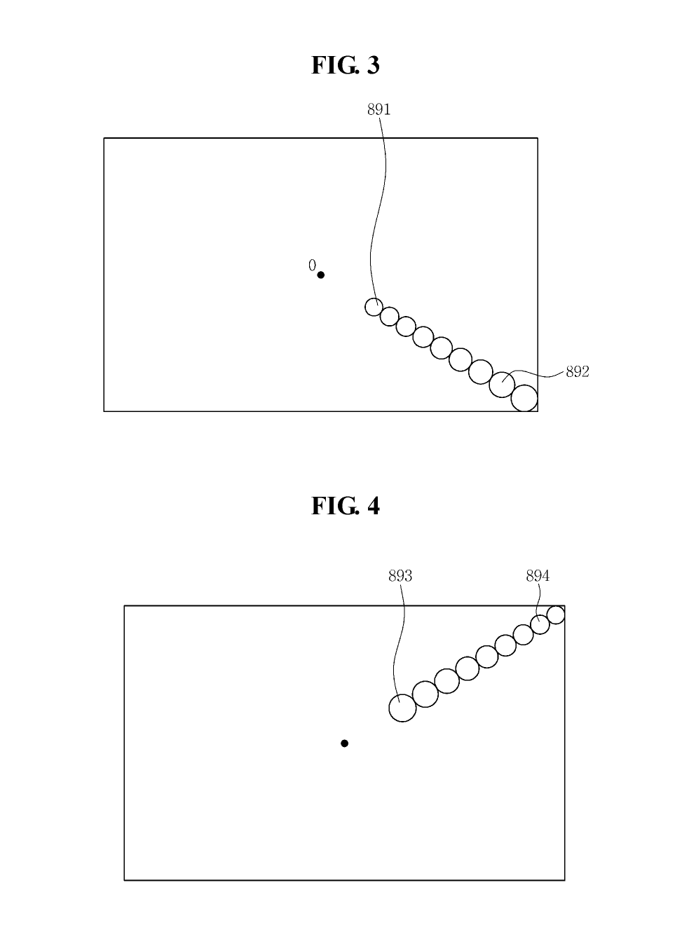

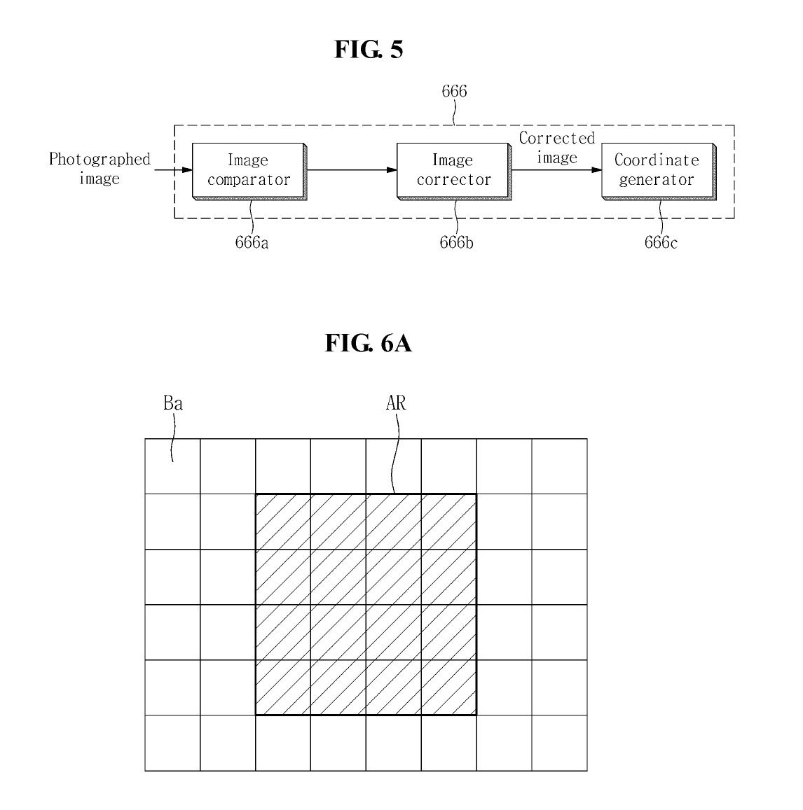

FIGS. 3 and 4 are views illustrating overlap of a total of nine images taken at time intervals. A ball 891 relatively close to a center 0 is an image of a previously photographed ball 891 and a ball 892 relatively far from the center 0 is an image of a ball 892 photographed later in time. In the case where a diameter of the ball 892 photographed later is larger than a diameter of the previously photographed ball 891, the location detector 666 determines that the ball is gradually ascending. On the other hand, as illustrated in FIG. 4, in the case where a diameter of a ball 894 photographed later is less than a diameter of a previously photographed ball 893, the location detector 666 determines that the ball is gradually descending.

Meanwhile, the baseball game system may be located indoors. When the baseball game system is located indoors, the illuminance of the interior depends on artificial lightings inside. An illuminance of a photographing area (that is, an area photographed by the photographing unit) may vary according to the brightness of the lighting. A change in illuminance of the photographing area affects a luminance of an image taken under the illuminance. For example, the higher the illuminance of the photographing area, the larger the size of the ball in the photographed image. Further, the lower the illuminance of the photographing area, the less the size of the ball in the photographed image. Accordingly, there may arise a problem that the vertical position of the ball changes according to the changes in illuminance.

In order to address such an issue, the location detector receives the photographed image from the photographing unit, compares the photographed image with a predetermined reference image, generates a corrected image by adjusting the luminance of the photographed image based on the comparison result, and detects the location of the pitched ball or the struck ball based on the corrected image.

In the case where the photographed image has a less luminance value than a luminance value of the reference image, the location detector increases the luminance of the photographed image to generate a corrected image. For example, the location detector may increase the luminance of the photographed image so that the luminance of the photographed image is substantially equal to the luminance of the reference image.

On the other hand, in the case where the photographed image has a larger luminance value than the luminance value of the reference image, the location detector decreases the luminance of the photographed image to generate a corrected image. For example, the location detector may decrease the luminance of the photographed image so that the luminance of the photographed image is substantially equal to the luminance of the reference image.

In an exemplary embodiment, in the case where the photographed image has a substantially same luminance value as that of the reference image, the location detector may not perform correction of the photographed image. For example, the location detector may detect the location of the pitched ball or the struck ball based on the photographed image without a separate corrected image.

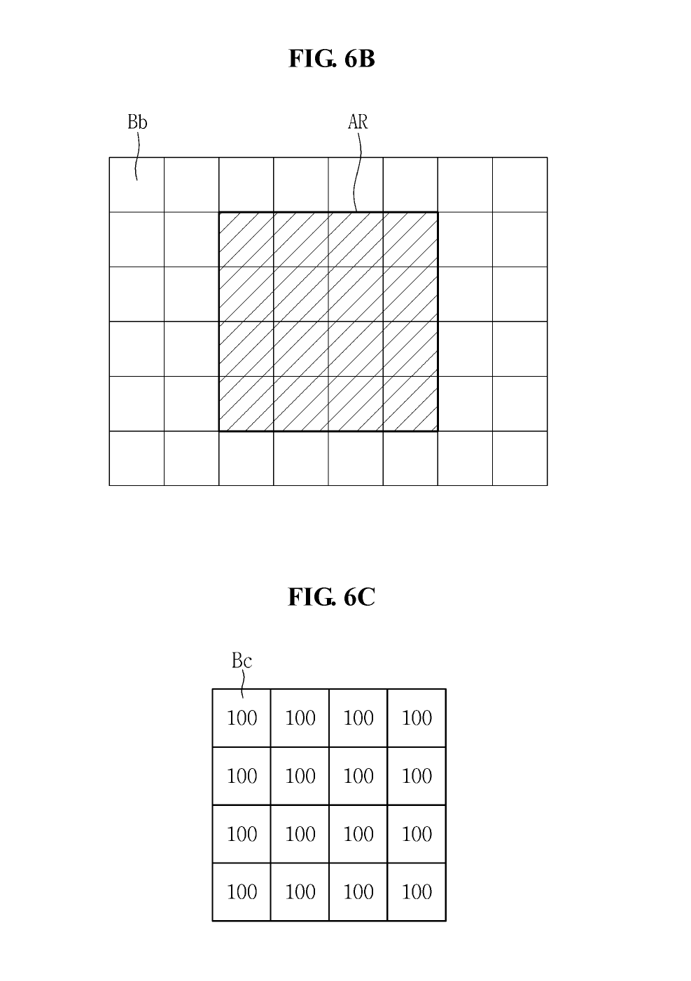

FIG. 5 is a block diagram illustrating the location detector of FIG. 1.

As illustrated in FIG. 5, the location detector 666 may include an image comparator 666a comparing the photographed image with the reference image, an image corrector 666b generating a corrected image based on the comparison result from the image comparator 666a, and a coordinate generator 666c generating coordinates of a ball based on the corrected image from the image corrector 666b.

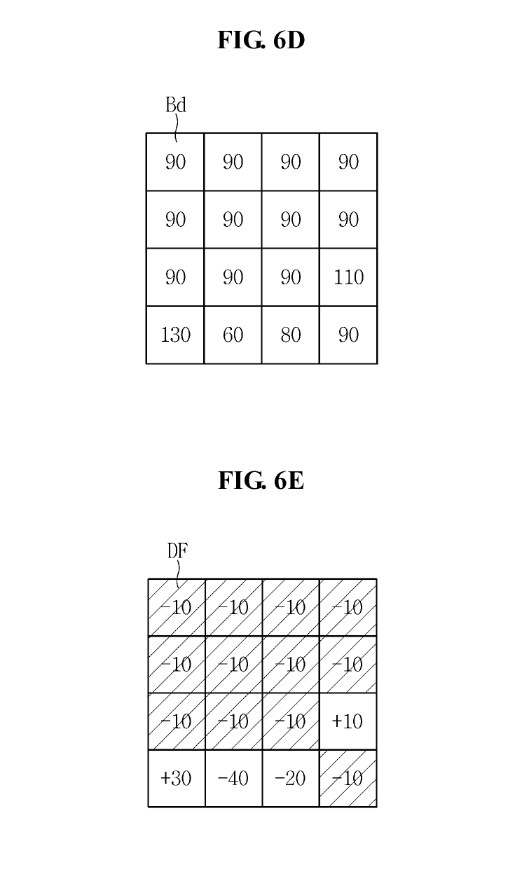

Hereinafter, the operation of the location detector will be described in detail with reference to FIGS. 6A, 6B, 6C, 6D and 6E.

FIG. 6A is a view illustrating a spatial arrangement of block luminance data included in a reference image of one frame.

As illustrated in FIG. 6A, the reference image of one frame includes a plurality of block luminance data Ba. For example, the reference image of one frame may include 48 block luminance data Ba. As illustrated in FIG. 6A, the 48 luminance block data Ba may be arranged in a matrix form of 8*6.

Each block luminance datum Ba includes a plurality of unit luminance data. For example, one block luminance datum Ba includes a plurality of unit luminance data.

Each block luminance datum Ba includes a luminance value of a corresponding block. For example, the luminance value of the aforementioned one block luminance datum Ba means an average luminance value of luminance values of a plurality of unit luminance data included in the one block luminance datum Ba. Herein, the unit luminance data represents luminance data corresponding to a unit pixel of the photographing unit 430. The unit pixel may include a red pixel, a green pixel and a blue pixel.

The image comparator 666a selects block luminance data located in a certain area (AR: a hatched area) among the luminance block data Ba of the reference image. For example, as illustrated in FIG. 6A, the image comparator 666a selects 16 luminance block data arranged spatially adjacent to each other among the entirety of 48 luminance block data Ba included in the reference image. As illustrated in FIG. 6A, the 16 luminance block data may be arranged in a matrix form of 4*4.

FIG. 6B is a view illustrating a spatial arrangement of block luminance data included in a photographed image of one frame.

As illustrated in FIG. 6B, the photographed image of one frame includes a plurality of block brightness data Bb. For example, the photographed image of one frame may include 48 block luminance data Bb. As illustrated in FIG. 6B, the 48 luminance block data Bb may be arranged in a matrix form of 8*6.

Each block luminance datum Bb includes a plurality of unit luminance data. For example, one block luminance datum Bb includes a plurality of unit luminance data.

Each block luminance datum Bb includes a luminance value of a corresponding block. For example, the luminance value of the aforementioned one block luminance datum Bb means an average luminance value of luminance values of a plurality of unit luminance data included in the one block luminance datum Bb. Herein, the unit luminance data represents luminance data corresponding to the unit pixel of the photographing unit 430. The unit pixel may include a red pixel, a green pixel and a blue pixel.

The image comparator 666a selects block luminance data located in a certain area (AR: a hatched area) among the luminance block data Bb of the photographed image. For example, as illustrated in FIG. 6B, the image comparator 666a selects 16 luminance block data arranged spatially adjacent to each other among the entirety of 48 luminance block data Ba included in the photographed image. As illustrated in FIG. 6B, the 16 luminance block data may be arranged in a matrix form of 4*4.

Next, the image comparator 666a subtracts the block luminance data selected from the reference image from each corresponding one of the block luminance data selected from the photographed image, respectively, thus generating a subtracted luminance datum. For example, a block luminance datum (hereinafter, a second luminance block datum) in the 10 o'clock direction in the certain area of FIG. 6A is subtracted from a block luminance datum (hereinafter, a first luminance block datum) in the 10 o'clock direction in the certain area of FIG. 6B. In other words, a luminance value of the second luminance block datum is subtracted from a luminance value of the first luminance block datum. A luminance value of the subtracted result is a subtracted luminance value and data having the subtracted luminance value is the subtracted luminance data. In the case of FIGS. 6A and 6B, a total of 16 subtracted luminance data are generated.

The image corrector 666b selects subtracted luminance data within a predetermined reference range among the subtracted luminance data from the image comparator 666a. Next, the image corrector 666b compares the number of the selected subtracted luminance data with a predetermined threshold value. In the case where the number of the selected subtracted luminance data is larger than the threshold value, the image corrector 666b calculates an average luminance value for the selected subtracted luminance data. Subsequently, the image corrector 666b corrects the luminance of the photographed image based on the generated average luminance value. The corrected photographed image data is a corrected image.

The operation of the image corrector 666b will be described in detail with reference to FIGS. 6C and 6D.

FIG. 6C is a view separately illustrating only block luminance data included in the certain area among the luminance data of the reference image illustrated in FIG. 6A.

The numerical value described on each block luminance datum Bc in FIG. 6C represents a luminance value of the corresponding block luminance datum Bc. As in an example illustrated in FIG. 6C, each of the block luminance data Bc selected from the reference image has a luminance value of 100. For example, as illustrated in FIG. 6C, the aforementioned second luminance block datum has a luminance value of 100.

FIG. 6D is a view separately illustrating only block luminance data included in the certain area among the luminance data of the photographed image illustrated in FIG. 6B.

The numerical value described on each block luminance datum Bd in FIG. 6D represents a luminance value of the corresponding block luminance datum Bd. As in an example illustrated in FIG. 6D, each of the block luminance data Bd selected from the photographed image has a luminance value selected from 90, 130, 60 and 80. For example, as illustrated in FIG. 6D, the aforementioned first luminance block datum has a luminance value of 90.

FIG. 6E is a view illustrating a spatial arrangement of subtracted luminance data obtained by subtracting the block luminance data illustrated in FIG. 6C from the block luminance data illustrated in FIG. 6D.

The numerical values described in FIG. 6E represent a difference between corresponding ones of the block luminance data. As described above, for example, a value obtained by subtracting the luminance value 100 of the second block luminance datum from the luminance value 90 of the first block luminance datum is −10, which is a luminance value of a subtracted luminance datum DF corresponding to a difference between the corresponding block luminance data. As illustrated in FIG. 6E, the subtracted luminance data DF have a value selected from −10, +10, +30, −40 and −20.

Next, subtracted luminance data within the reference range among the subtracted luminance data DF of FIG. 6E are selected. For example, the reference range is expressed in Formulas 1 and 2 below.

−15<Y<−5 <Formula 1>

5<Y<15 <Formula 2>

In Formulas 1 and 2, Y represents the luminance value of the subtracted luminance data.

Among the subtracted luminance data DF illustrated in FIG. 6E, subtracted luminance data having a luminance value of −10 satisfying the above-described Formula 1 are 12 in total. Further, among the subtracted luminance data DF illustrated in FIG. 6E, subtracted luminance data having a luminance value of +10 satisfying the above-described Formula 2 are 1 in total.

The threshold value may be set, for example, to be a value corresponding to about 60% of the total number of the subtracted luminance data DF in the certain area. In such an exemplary embodiment, the decimal point is rounded up. For example, in the case where there are a total of 16 subtracted luminance data DF as illustrated in FIG. 6E, 10 may be set as a threshold value. In the case where the threshold value is 10, the number 12 of subtracted luminance data satisfying Formula 1 exceeds the threshold value. Accordingly, an average luminance value for the subtracted luminance data satisfying Formula 1 is calculated. According to FIG. 6E, this average luminance value is −10. Then, the image corrector 666b corrects the luminance value of the photographed image based on the average luminance value of −10.

In the case where the average luminance value has a value less than 0, the corrected image data have a higher luminance value than a luminance value of the photographed image data. On the other hand, in the case where the average luminance value has a greater value than 0, the corrected image data has a less luminance value than a luminance value of the photographed image data.

As the average luminance value decreases below zero, a difference between the luminance value of the corrected image data and the luminance value of the photographed image data increases. On the other hand, as the average luminance value increases above 0, the difference between the luminance value of the corrected image data and the luminance value of the photographed image data increases.

Although not illustrated, in the case where the number of the subtracted luminance data DF that satisfy Formula 2, and not Formula 1, is larger than the threshold value, an average luminance value for the subtracted luminance data is larger than 0. In such an exemplary embodiment, the corrected image data has a less luminance value than a luminance value of the photographed image data.

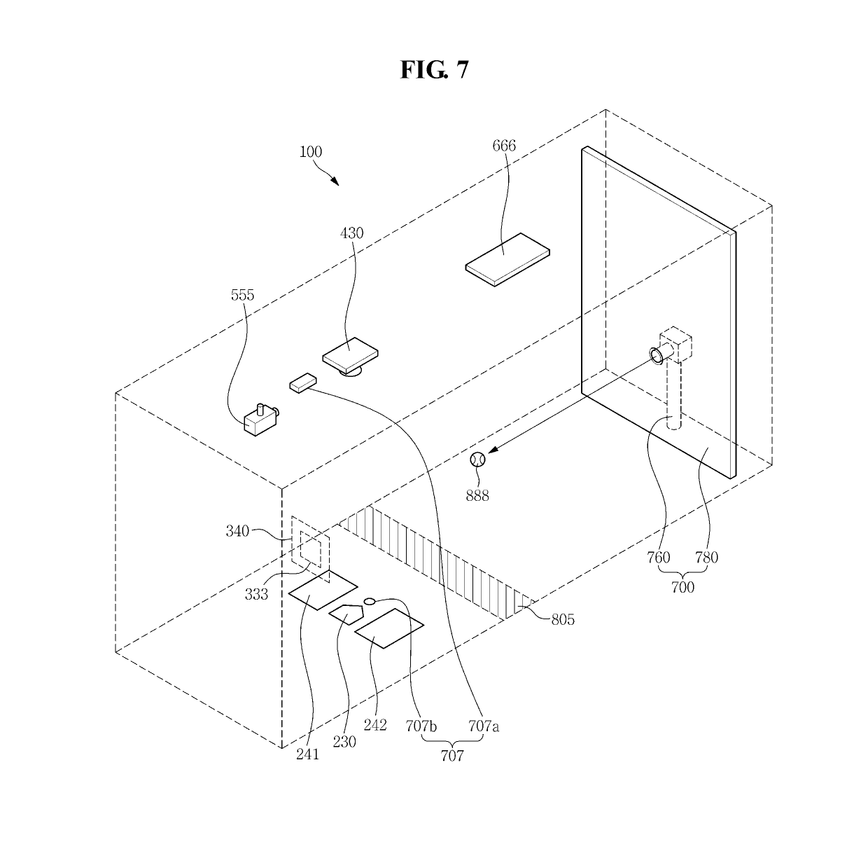

Meanwhile, the baseball game system according to an exemplary embodiment may be implemented outdoors. In such an exemplary embodiment, outdoor illuminance depends on natural light. Such natural light may be measured by an illuminometer, which will be described in detail with reference to FIG. 7.

FIG. 7 is a schematic perspective view illustrating a baseball game system according to an alternative exemplary embodiment.

As illustrated in FIG. 7, the baseball game system 100 according to an exemplary embodiment includes a pitching unit 700, a photographing unit 430, a projector 555, a location detector 666, a first plate 241, a second plate 242, a groove plate 230 and an illuminance measurement unit 707.

The illuminance measurement unit 707 measures an illuminance of a photographing area of the photographing unit 430. The illuminance measurement unit 707 may include at least one of a first illuminometer 707a and a second illuminometer 707b.

The first illuminometer 707a may be positioned between the first plate 241 and the second plate 242. In an alternative exemplary embodiment, although not illustrated, the first illuminometer 707a may be positioned at the groove plate 230. For example, the groove plate 230 may have a hole passing through a central portion of the groove plate 230, and the first illuminometer 707a may be inserted into the hole. The first illuminometer 707a may measure the illuminance of the photographing area through the hole.

The second illuminometer 707b may be positioned above the groove plate 230. In such an exemplary embodiment, the second illuminometer 707b may be positioned between the projector 555 and the photographing unit 430.

The location detector 666 receives a photographed image from the photographing unit 430, generates a corrected image by adjusting a luminance of the photographed image based on the illuminance measured by the illuminance measurement unit 707, and detects a location of a pitched ball or a struck ball based on the corrected image.

In the case where the illuminance measured by the illuminance measurement unit 707 is less than the reference illuminance, the corrected image may have a higher luminance value than that of the photographed image. Further, in the case where the illuminance measured by the illuminance measurement unit 707 is higher than the reference illuminance, the corrected image may have a less luminance value than that of the photographed image. On the other hand, in the case where the illuminance measured by the illuminance measurement unit 707 is substantially equal to the reference illuminance, no corrected image is generated. For example, the location detector 666 detects the location of the pitched ball or the struck ball based on the photographed image without the corrected image.

The pitching unit 700, the photographing unit 430, the projector 555, the first plate 241, the second plate 242 and the groove plate 230 illustrated in FIG. 7 are substantially identical to those described above with reference to FIGS. 1 and 2, and thus descriptions pertaining thereto will make reference to FIGS. 1 and 2 and the related descriptions.

As set forth hereinabove, the baseball game system according to one or more exemplary embodiments may provide the following effects.

The baseball game system according to one or more exemplary embodiments may accurately determine the location of the ball at all times irrespective of changes in illuminance.

While the present invention has been illustrated and described with reference to the exemplary embodiments thereof, it will be apparent to those of ordinary skill in the art that various changes in form and detail may be made thereto without departing from the spirit and scope of the present invention.

What is claimed is:

1. A baseball game system comprising:
a pitching unit pitching a ball toward a determination area comprising a strike zone;
a photographing unit between the determination area and the pitching unit; and
a location detector receiving a photographed image from the photographing unit, comparing the photographed image with a reference image, generating a corrected image by adjusting a luminance of the photographed image based on the comparison result and detecting a location of a pitched ball or a struck ball based on the corrected image.

2. The baseball game system as claimed in claim 1, wherein the reference image comprises a ball image photographed at a predetermined reference illuminance and the photographed image comprises a ball image photographed at an illuminance at the time of photographing by the photographing unit.

3. The baseball game system as claimed in claim 1, wherein the location detector generates the corrected image by increasing the luminance of the photographed image when the photographed image has a less luminance value than a luminance value of the reference image and
generates the corrected image by decreasing the luminance of the photographed image when the photographed image has a higher luminance value than the luminance value of the reference image.

4. The baseball game system as claimed in claim 1, wherein the location detector comprises:
an image comparator comparing the photographed image with the reference image; and
an image corrector generating the corrected image based on the comparison result from the image comparator.

5. The baseball game system as claimed in claim 4, wherein the image comparator selects block luminance data located in a certain area among block luminance data of the reference image,
selects block luminance data located in the certain area among block luminance data of the photographed image and
subtracts the block luminance data selected from the reference image from each corresponding one of the block luminance data selected from the photographed image, respectively, to generate subtracted luminance data.

6. The baseball game system as claimed in claim 5, wherein the image corrector selects subtracted luminance data located within a reference range among the subtracted luminance data from the image comparator,
calculates an average luminance value of the selected subtracted luminance data when the number of the selected subtracted luminance data is larger than a threshold value, and
generates the corrected image by correcting the luminance of the photographed image based on the average luminance value.

7. The baseball game system as claimed in claim 6, wherein in the image corrector,
the corrected image datum has a higher luminance value than a luminance value of the photographed image datum when the average luminance value is less than 0, and
the corrected image datum has a less luminance value than the luminance value of the photographed image datum when the average luminance value is larger than 0.

8. A baseball game system comprising:
a pitching unit pitching a ball toward a determination area comprising a strike zone;
a photographing unit between the determination area and the pitching unit;
an illuminometer measuring an illuminance of a photographing area of the photographing unit; and
a location detector receiving a photographed image from the photographing unit, generating a corrected image by adjusting a luminance of the photographed image based on the illuminance measured by the illuminometer, and detecting a location of a pitched ball or a struck ball based on the corrected image.

9. The baseball game system as claimed in claim 8, wherein the corrected image has a higher luminance value than a luminance value of the photographed image when the illuminance measured by the illuminometer is less than a reference illuminance.

10. The baseball game system as claimed in claim 8, wherein the corrected image has a less luminance value than a luminance value of the photographed image when the illuminance measured by the illuminometer is higher than a reference illuminance.
